(19) United States
(12) Patent Application Publication
(10) Pub. No.: US 2010/0187481 A1
(43) Pub. Date: Jul. 29, 2010

(54) USE OF IONIC LIQUIDS TO IMPROVE THE PROPERTIES OF LUBRICATING COMPOSITONS

(76) Inventors: Günther Bodesheim, Munchen (DE); Martin Scgnudt-Amelunxen, Arzbach (DE); Dieter Sohn, Ammersee (DE); Stefan Grundei, Mering (DE); Andrea Höpke, Mainhausen (DE)

Correspondence Address: KUBOVCIK & KUBOVCIK, SUITE 1105, 1215 SOUTH CLARK STREET, ARLINGTON, VA, 22202, US

(21) Appl. No.: 12/452,218

(22) PCT Filed: May 20, 2008
(86) PCT No.: PCT/EP2008/004036

§ 371 Date: Mar. 22, 2010

(30) Foreign Application Priority Data
Jun. 20, 2007 (DE) 102007028427.8

(51) Int. Cl. C09K 15/32; C09K 15/00; C09K 15/08; C09K 15/06; C09K 15/10; C09K 15/16

(52) U.S. Cl. 252/400.2; 252/397; 252/400.3; 252/404; 252/407; 252/399; 252/406; 252/405

(57) ABSTRACT

The invention relates to the use of ionic liquids for improving the lubricating effect of synthetic, mineral and native oils. The invention relates in particular to an improved lubricating composition that is protected from thermal and oxidative attack.

The invention relates to the use of ionic liquids to improve the lubrication effect of synthetic, mineral and native oils. In particular the invention relates to an improved lubricating composition that is protected against thermal and oxidative attack.

Lubricants are used in automotive engineering, conveyor technology, mechanical engineering, office technology and in industrial factories and machines but also in the fields of household appliances and entertainment electronics.

In roller bearings and frictions bearings, lubricants ensure that a separating film of lubricant which transfers the load is built up between parts rolling or sliding against one another. This achieves the result that the metallic surfaces do not come in contact and therefore no wear occurs. These lubricants must therefore meet high demands, which include extreme operating conditions such as very high or very low rotational speeds, high temperatures due to high rotational speeds or due to outside heating, very low temperatures, e.g., in bearings that operate in a cold environment or that occur with use in aeronautics and space travel. Likewise, modern lubricants should be usable under so-called clean room conditions to prevent contamination of the clean room due to abrasion and/or consumption of lubricants. Furthermore, when using modern lubricants, they should be prevented from vaporizing and therefore “lackifying,” i.e., becoming solid after a brief use and therefore no longer having a lubricating effect. Special demands are also made of lubricants during use, so that the running properties of the bearings are not attacked thanks to low friction, the bearings must run with a low noise level and with long running times must be achieved without relubrication. Lubricants must also resist the action of forces such as centrifugal force, gravitational force and vibrations.

The service life and lubricating effect of synthetic, mineral and native oils are limited by their thermal and oxidative degradation. Therefore, amine and/or phenolic compounds have been used in the past as antioxidants, but they, have the disadvantage that they have a high vapor pressure and a short lifetime, which is why the oils “lackify” after a relatively short period of use, i.e., they become solid and therefore can cause major damage to the equipment especially in the area of roller bearings and friction bearings.

The goal of the present invention was therefore to provide a lubricating composition which will meet the requirements specified above and whose thermal and oxidative stability will be improved in comparison with known lubricants.

This goal has surprisingly been achieved by adding ionic liquids to synthetic mineral and native oils. A lubricating grease composition is provided, consisting of a base oil of a synthetic oil, a mineral oil or a native oil, individually or in combination, to which ionic liquids and optionally conventional additives are added. It has been found that the addition of ionic liquids prolongs the lifetime of the oils and thus the service life by significantly delaying thermal and oxidative degradation.

The synthetic oils are selected from esters of aromatic or aliphatic di-, tri- or tetracarboxylic acids with one or a mixture of C₇ to C₂₂ alcohols, a polyphenyl ether or alkylated di- or triphenyl ether, an ester of trimethylolpropane, pentaerythritol or dipentaerythritol with aliphatic C₇ to C₂₂ carboxylic acids, from C₁₈ dimeric acid esters with C₇ to C₂₂ alcohols, from complex esters, as single components or in any mixture. In addition, the synthetic oil may be selected from poly-α-olefins, alkylated naphthalenes, alkylated benzenes, polyglycols, silicone oils, perfluoropolyethers.

The mineral oils may be selected from paraffin-basic oils, naphthene-basic oils and aromatic hydrocracking oils; GTL fluids. GTL stands for the gas-to-liquid process and describes a method of producing fuel from natural gas. Natural gas is converted by steam reforming to synthesis gas, which is then converted to fuels by means of catalysts according to Fischer-Tropsch synthesis. The catalysts and the process conditions determine which type of fuel is produced, i.e., whether gasoline, kerosene, diesel or oils will be produced. In the same way, coal may also be used as a raw material in the coal-to-liquid process (CTL) and biomass may be used as a raw material in the biomass-to-liquid (BTL) process.

Triglycerides from animal/plant sources may be used as native oils and may be refined by known methods such as hydrogenation. The especially preferred triglycerides are genetically modified triglycerides with a high oleic acid content. Vegetable oils with a high oleic acid content that have been genetically modified and are typically used in this way include safflower oil, corn oil, canola oil, sunflower oil, soy oil, linseed oil, peanut oil, lesquerella oil, meadowfoam oil and palm oil.

The use of native oils based on renewable raw materials in particular is important because of their advantages with regard to biodegradability and reducing or preventing CO₂ emissions because it is possible in this way to avoid the use of petroleum as a raw material while achieving identical if not better results with native oils.

Ionic liquids, hereinafter also referred to as IL (=ionic liquid), are so-called salt melts which are preferably liquid at room temperature and/or by definition have a melting point <100° C. They have almost no vapor pressure and therefore have no cavitation properties. In addition, through the choice of the cations and anions in the ionic liquids, the lifetime and lubricating effect of the lubricating composition are increased, the lackification described above is delayed, and by adjusting the electric conductivity, it is now possible to use these liquids in equipment in which there is an electric charge buildup. Suitable cations for ionic liquids have been found to include a quaternary ammonium cation, a phosphonium cation, an imidazolium cation, a pyridinium cation, a pyrazolium cation, an oxazolium cation, a pyrrolidinium cation, a piperidinium cation, a thiazolium cation, a guanidinium cation, a morpholinium cation, a trialkylsulfonium cation or a triazolium cation, which may be substituted with an anion selected from the group consisting of [PF₆]⁻, [BF₄]³¹ , [CF₃CO₂]³¹ , [CF₃SO₃]⁻ as well as its higher homologs, [C₄F₉—SO₃]³¹ or [C₈F₁₇—SO₃]⁻ and higher perfluoroalkylsulfonates, [(CF₃SO₂)₂N]⁻, [(CF₃SO₂)(CF₃COO)N]⁻, [R⁴—SO₃]⁻, [R⁴—O—SO₃]³¹ , [R⁴—COO]⁻, Cr⁻, Br⁻, [NO₃]⁻, [N(CN)₂]⁻, [HSO₄]⁻, PF₍₆₋ₓ₎R⁶ₓ or [R⁴R⁵PO₄]⁻ and the radicals R⁴ and R⁵ independently of one another are selected from hydrogen; linear or branched, saturated or unsaturated, aliphatic or alicyclic alkyl groups with 1 to 20 carbon atoms; heteroaryl, heteroaryl-C₁-C₆-alkyl groups with 3 to 8 carbon atoms in the heteroaryl radical and at least one heteroatom of N, O and S, which may be combined with at least one group selected from C₁-C₆ alkyl groups and/or halogen atoms; aryl-aryl C₁-C₆ alkyl groups with 5 to 12 carbon atoms in the aryl radical, which may be substituted with at least one C₁-C₆ alkyl group; R⁶ may be a perfluoroethyl group or a higher perfluoroalkyl group, x is 1 to 4. However, other combinations are also possible.

Ionic liquids with highly fluorinated anions are especially preferred because they usually have a high thermal stability. The water uptake ability may definitely be reduced by such anions, e.g., in the case of the bis(trifluoromethylsutfonyl)imide anion.

Examples of such ILs include:

butylmethylpyrrolidinium bis(trifluoromethylsulfonyl)imide (MBPimide),

methylpropylpyrrolidinium bis(trifluoromethylsulfonyl)imide (MPPimide),

hexylmethylimidazolium tris(perfluoroethyl)trifluorophosphate (HMIMPFET),

hexylmethylimidazolium bis(trifluoromethylsulfonyl)imide (HMIMimide),

hexylmethylpyrrolidinium bis(trifluoromethylsulfonyl)imide (HMP),

tetrabutylphosphonium tris(perfluoroethyl)trifluorophosphate (BuPPFET),

octylmethylimidazolium hexafluorophosphate (OMIM PF6),

hexylpyridinium bis(trifluoromethyl)sulfonylimide (Hpyimide),

methyltrioctylammonium trifluoroacetate (MOAac),

butylmethylpyrrolidinium tris(pentafluoroethyl)trifluorophosphate (MBPPFET),

trihexyl(tetradecyl)phosphonium bis(trifluoromethylsulfonyl)imide (HPDimide).

In addition, the inventive lubricating compositions contain the usual additives or additive mixtures selected from anticorrosion agents, antioxidants, wear preventives, friction-reducing agents, agents to protect against the effects of metals which are present as chelate compounds, radical scavengers, UV stabilizers, reaction-layer-forming agents as well as organic or inorganic solid lubricants such as polyimide, polytetrafluoroethylene (PTFE), graphite, metal oxides, boron nitride, molybdenum disulfide and phosphate. In particular, additives in the form of compounds containing phosphorus and sulfur, e.g., zinc dialkyl dithiophosphate, boric acid esters may be used as antiwear/extreme pressure agents, metal salts, esters, nitrogenous compounds, heterocyclic agents may be used as anticorrosion agents, glycerol monoesters or diesters may be used as friction preventives and polyisobutylene, polymethacrylate may be used as viscosity improvers.

The inventive lubricating compositions contain 5 to 95 wt % base oil or base oil mixture, 0.05 to 40 wt % ionic liquid and optionally 0.1 to 10 wt % additives.

The inventive lubricating compositions may be used as high-temperature chain saw oils by adding ionic liquids because they may be used at temperatures up to 250° C. By lowering the electric resistance of the oils, they may be used in areas where repeated damage incidents due to electricity due sparkovers, as in the case of railway wheel bearings and roller bearings with a current feed-through, and in the automotive field or with electric motors, for example.

Ionic liquids are superior to phenol-based or amine-based antioxidants or perfluorinated salts as thermal and oxidative stabilizers due to the solubility in organic systems and/or solvents and/or because of the extremely low vapor pressure. In large proportions, no crystals which could then lead to noise and blockage are formed in the lubricants containing ionic liquids, e.g., in friction ring seals, which could thus damage these components.

The thermal and oxidative stability of the inventive lubricating compositions is manifested in the delay in evaporation and the rise in viscosity, so that the lackification of the system at high temperatures is delayed and the lubricants can be used for a longer period of time.

The advantages of the inventive lubricating compositions are shown on the basis of the following examples.

### EXAMPLES

The percentage amounts are given in percent by weight (wt %), unless otherwise indicated.

1. Reduction in the Electric Resistance of the Oils Due to the Addition of Ionic Liquids

Various base oils were measured alone and in combination with various ionic liquids in various concentrations. The polypropylene glycol that is used is a butanol-initiated polypropylene glycol. The synthetic ester is dipentaerythritol ester with short-chain fatty acids available under the brand name Hatco 2926.

The measurements of the specific electric resistivity were performed with plate electrodes having an area of 2.5 cm² and a spacing of 1.1 cm with a measurement voltage (DC) of 10 V. Three measurements were performed for each, and Table 1 shows the averages of the measurements.

TABLE 1

| | Specific Electric |
|---|---|
| Lubricating Grease Composition (Q · cm) | Resistivity |
| 100% polypropylene glycol | 10 × 10¹⁰ |
| 99.0% polypropylene glycol + 1% HDPimide | 6 × 10⁶ |
| 100% synthetic ester | 7 × 10¹⁰ |
| 99.0% synthetic ester + 1% HDPimide | 7 × 10⁶ |
| 95.0% synthetic ester + 5% HDPimide | 1 × 10⁶ |
| 100% solvent raffinate N 100/40 pure | <10¹³ |
| 99.0% solvent raffinate N 100/40 + 1% PCl | 1 × 10¹¹ |
| 99.9% solvent raffinate N 100/40 + 0.1% PCl | 1 × 10¹² |

HDPimide: trihexyl(tetradecyl)phosphonium bis(trifluoromethylsulfonyl)imide
PCl: trihexyltetradecylphosphonium chloride

The measurement results thus obtained show that by adding ionic liquids, the specific electric resistivity of the lubricating oil composition is lowered.

2. Influence of the Ionic Liquids on the Friction Value and Wear on the Example of a Polypropylene Glycol

n-Butanol-initiated polyalkylene glycol available under the brand name Synalox 55-150B was used. A vibration friction wear test (SRV) was performed according to DIN 51834, test conditions: ball/plate, 200 N load at 50° C., 1 mm stroke at 50 Hz for 20 minutes. The results are shown in Table 2.

TABLE 2

| | Wear factor/Flow/ |
|---|---|
| Lubricating Grease Composition | Friction additive |
| 100% polyalkylene glycol | 2850/slightly wavy/0.15 |
| 99.5% polyalkylene glycol + 0.5% OMIM PF6 | 41/very smooth/0.11 |
| 98.0% polyalkylene glycol + 2% OMIM PF6 | 108/very smooth/0.11 |

OMIM PF6: octylmethylimidazolium hexafluorophosphate

These results show the positive influence of the ionic liquids on the friction value and the wear of the lubricating grease composition.

3. Influence of the Ionic Liquids on the Viscosity and the Loss on Evaporation of Lubricating Grease Compositions

These investigations were first conducted at 150° C. with 1 g weight of the lubricating grease composition. To do so, the samples were weighed into aluminum dishes and tempered in a circulating air oven, namely for 96 and 120 hours in the present case. After the test time, the cooled dishes were weighed and the weight loss relative to the initial weight was determined. The apparent dynamic viscosity of the fresh oils as well as the used oils was determined using a ball/plate rheometer at 300 sec⁻¹ at 25° C. after a measurement time of 60 seconds.

In addition, thermogravimetric analysis (TGA) were performed using a TG/DTA 6200 device from the company Seiko with an initial weight of 10 mg±0.2 mg in an open aluminum crucible, purging gas air, temperature ramp 1 K/min from 100 to 260° C.

Dipentaerythritol ester with short-chain, fatty acids, available under the brand name Hatco 2926 was used as the synthetic ester for these analyses. The percentage amounts are wt %. The results are shown in Table 3.

TABLE 3

| | Sample | | | |
|---|---|---|---|---|
| Apparent dynamic | 100% synthetic | 99.5% synthetic | 98.0% synthetic | 89.6% synthetic |
| viscosity fresh | ester pure | ester + 0.5% | ester + 2% | ester + 10.4% |
| | 130 mPas | HDPimide 140 mPas | HDPimide 140 mPas | HDPimide 160 mPas |
| LOE and apparent | 39.6% | 21.3% | 13.6% | 8.5% |
| dynamic viscosity after | 13,500 mPas | 1400 mPas | 580 mPas | 360 mPas |
| 96 hours at 150° C. | | | | |
| LOE and apparent | 48.5% | 25.3% | 15.7% | 10.6% |
| dynamic viscosity after | 70,000 mPas | 2400 mPas | 700 mPas | 460 mPas |
| 120 hours at 150° C. | | | | |
| TGA LOE up to 260° C. | 40.0% | 35.4% | 32.5% | 23.2% |
| according to KL | | | | |
| standard | | | | |

LOE: loss on evaporation
HDPimide: trihexyl(tetradecyl)phosphonium bis(trifluoromethylsulfonyl)imide

These results show that with high-temperature oils, a definite reduction in viscosity and reduction in the loss on evaporation under temperature loading TGA-LOE (5 g initial weight at 230° C.) can be observed in high-temperature oils due to the addition of ionic liquids without the addition of other antioxidants in the lubricating grease composition.

4. Influence of the Ionic Liquids on the Viscosity and Evaporation under Thermal Loading (1 g Initial Weight at 200° C.) of the Lubricating Oil in Combination with a Known Antioxidant

An amine antioxidant (Naugalube 438L) in a concentration of 1 wt % was used in all the samples tested subsequently, while a synthetic ester was used as the base oil. The synthetic ester was a dipentaerythritol ester with short-chain fatty acids available under the brand name Hatco 2926. The ionic liquids used are listed below.

TABLE 4
Effect on viscosity

| | | Initial | Viscosity | Viscosity | Viscosity |
|---|---|---|---|---|---|
| | | viscosity* | in mPas | in mPas | in mPas |
| Ionic liquid | Oil | in mPas | after 24 h | after 48 h | after 72 h |
| — | 99.0% synthetic ester | 173 | lackified | lackified | lackified |
| 0.1% MBPimide | 98.9% synthetic ester | 182 | lackified | lackified | lackified |
| 0.3% MBPimide | 98.7% synthetic ester | 192 | 93,517 | lackified | lackified |
| 0.1% HMP | 98.9% synthetic ester | 176 | 176,740 | lackified | lackified |
| 0.3% HMP | 98.7% synthetic ester | 187 | 63,402 | lackified | lackified |
| 0.1% HMIMimide | 98.9% synthetic ester | 176 | lackified | lackified | lackified |
| 0.3% HMIMimide | 98.7% synthetic ester | 185 | 30,100 | lackified | lackified |
| 0.1% BuPPFET | 98.9% synthetic ester | 176 | lackified | lackified | lackified |
| 0.3% BuPPFET | 98.7% synthetic ester | 181 | 70,776 | lackified | lackified |
| 0.1% HPYimide | 98.9% synthetic ester | 185 | 25,208 | lackified | lackified |
| 0.3% HPYimide | 98.7% synthetic ester | 176 | 4314 | 24,367 | lackified |
| 0.1% MoAac | 98.9% synthetic ester | 176 | lackified | lackified | lackified |
| 0.3% MoAac | 98.7% synthetic ester | 178 | lackified | lackified | lackified |
| 0.1% MBPPFET | 98.9% synthetic ester | 179 | 21,164 | lackified | lackified |
| 0.3% MBPPFET | 98.7% synthetic ester | 181 | 14,817 | 22,392 | lackified |
| 0.1% | 98.9% synthetic ester | 178 | 79,979 | lackified | lackified |
| HMIMPFET | | | | | |
| 0.3% | 98.7% synthetic ester | 179 | lackified | lackified | lackified |
| HMIMPFET | | | | | |
| 1.0% MBPimide | 98.0% synthetic ester | 181 | 14,726 | 46,721 | lackified |
| 0.1% HDPimide | 98.9% synthetic ester | 174 | 90,883 | lackified | lackified |
| 0.3% HDPimide | 98.7% synthetic ester | 178 | 55,759 | lackified | lackified |

*Apparent dynamic viscosity after 60 sec shear time at 300 sec⁻¹, cone/plate 20° C.
MBPimide = butylmethylpyrrolidinium bis(trifluoromethylsulfonyl)imide
HMP = hexylmethylpyrrolidinium bis(trifluoromethylsulfonyl)imide
HMIMimide = hexylmethylimidazolium bis(trifluoromethylsulfonyl)imide
BuPPFET = tetrabutylphosphonium tris(perfluoroethyl)trifluorophosphate
HPYimide = hexylpyridinium bis(trifluoromethyl)sulfonylimide
MOAac = methyltrioctylammonium trifluoroacetate
MBPPFET = butylmethylpyrrolidinium tris(pentafluoroethyl)trifluorophosphate
HMIMPFET = hexylmethylimidazolium tris(perfluoroethyl)trifluorophosphate
HPDimide = trihexyl(tetradecyl)phosphonium bis(trifluoromethylsulfonyl)imide

TABLE 4a
Effect on the loss on evaporation

| | | Loss on evaporation |
|---|---|---|
| Ionic liquid | Oil | after 24 hours |
| — | 99.0% synthetic ester | 70-75% |
| 0.3% HMP | 98.7% synthetic ester | 53% |
| 0.3% HPYimide | 98.7% synthetic ester | 39% |
| 0.3% HDPimide | 98.7% synthetic ester | 53% |

The above results show that the increase in viscosity and the loss on evaporation of the lubricants are reduced by the addition of an ionic liquid. Furthermore, it has been shown that a lubricant containing only an amine antioxidant is “lackified” after only 24 hours, whereas lackification does not occur until after 24 to 48 hours when the ionic liquid is added. When 0.3 wt % HPYimide and/or MBPPFET as well as 1.0 wt % MBPimide is/are added, the lubricant does not lackify until 48 to 72 hours. In addition, the loss on evaporation of the lubricants is reduced. Table 5 summarizes the results of Table 4.

TABLE 5

| | Lackification |
|---|---|
| Lubricating composition | time |
| 99.0% synthetic ester + 1% amine antioxidant | <7 hours |
| 98.9 and/or 98.7% synthetic ester + 1% amine | >24 hours |
| antioxidant + 0.1 and/or 0.3% MBPimide; HMP; | and <48 hours |
| HMIMimide; BuPPFET; MBPPFET; HIMIMPFET; | |
| HDPimide and/or 0.1% HPYimide or 0.1% | |
| MBPPFET | |
| 98.9 and/or 98.7% synthetic ester + 1% amine | >48 hours |
| antioxidant + 0.3% HPYimide or MBPPFET or 1.0% | and <72 hours |
| MBPimide | |

5. Influence of Ionic Liquids on Native Ester Oils with Regard to Evaporation and Viscosity Under Thermal Loading of 1 g Starting Weight at 140° C.

Rümanol 404 blown rapeseed oil was used as the native ester oil. An amine antioxidant (Naugalube 438L) in a concentration of 1 wt % was used in all the samples tested subsequently. The ionic liquids used are listed below.

TABLE 6

| | | Initial | Viscosity | Viscosity | Viscosity |
|---|---|---|---|---|---|
| | | viscosity* | in mPas | in mPas | in mPas |
| Ionic liquid | Oil | in mPas | after 24 h | after 48 h | after 72 h |
| — | 99.0% native ester oil | 112 | 20,152 | lackified | lackified |
| 0.1% MoAac | 98.9% native ester oil | 123 | 505 | 39,177 | lackified |
| 0.3% MoAac | 98.7% native ester oil | 127 | 176 | 21,856 | lackified |
| 0.1% Ecoeng | 98.9% native ester oil | 121 | 72,249 | lackified | lackified |
| 500 | | | | | |
| 0.3% Ecoeng | 98.7% native ester oil | 117 | 34,383 | lackified | lackified |
| 500 | | | | | |
| 0.1% HDPimide | 98.7% native ester oil | 118 | 15,303 | lackified | lackified |
| 0.3% HDPimide | 98.9% native ester oil | 114 | 14,641 | lackified | lackified |
| 1.0% MOAac | 98.0% native ester oil | 124 | 120 | 1613 | lackified |

*Apparent dynamic viscosity after 60 s shear time at 300 sec⁻¹, cone/plate 20° C.
MOAac = methyltrioctylammonium trifluoroacetate
HPDimide = trihexyl(tetradecyl)phosphonium bis(trifluoromethylsulfonyl)imide
Ecoeng 500 = PEG-5 cocomonium methyl sulfate

TABLE 6a

| | | Loss on evaporation |
|---|---|---|
| Ionic liquid | Oil | after 24 hours |
| — | 99.0% native ester oil | 7.0% |
| 0.1% MOAac | 98.9% native ester oil | 2.6% |
| 0.3% MOAac | 98.7% native ester oil | 1.8% |
| 0.1% HDPimide | 98.9% native ester oil | 2.9% |
| 0.3% HDPimide | 98.7% native ester oil | 3.0% |
| 1.0% MOAac | 98.0% native ester oil | 2.0% |

The results above show that the increase in viscosity and the loss on evaporation of the native ester oil are reduced by adding an ionic liquid. In addition, it has been shown that a native ester oil containing only an amine antioxidant is “lackified” after 24 to 48 hours, whereas lackification does not occur until after 48 to 72 hours when the ionic liquid is added. Table 7 summarizes the results of Table 6.

TABLE 7

| Lubricating grease composition | Lackification time |
|---|---|
| 99% native ester oil + 1% amine | >24 h and <48 h |
| antioxidant | |
| Native ester oil + 1% amine | >48 h and <72 h plus a reduction |
| antioxidant + MOAac in various | in viscosity in comparison with the |
| concentrations from 0.1 to 1% | standard! |

6. Influence of Ionic Liquids on Natural Ester Oils with Regard to Evaporation and Viscosity Under Temperature Loading of 1 g Initial Weight at 140° C.

Sunflower oil was used as the natural ester oil. An amine antioxidant (Naugalube 438L) in a concentration of 1 wt % was used in all the samples tested subsequently. The ionic liquids used are listed below.

TABLE 8

| | | Initial | Viscosity | Viscosity | Viscosity |
|---|---|---|---|---|---|
| | | viscosity* | in mPas | in mPas | in mPas |
| Ionic liquid | Oil | in mPas | after 24 h | after 48 h | after 72 h |
| — | 99.0% sunflower oil | 102 | 14,190 | lackified | lackified |
| 0.1% MoAac | 98.9% sunflower oil | 113 | 142 | 51,891 | lackified |
| 0.3% MoAac | 98.7% sunflower oil | 108 | 173 | 13,820 | lackified |
| 0.1% Ecoeng | 98.9% sunflower oil | 106 | 4652 | lackified | lackified |
| 500 | | | | | |
| 0.1% HDPimide | 98.9% sunflower oil | 113 | 5580 | lackified | lackified |
| 0.3% HDPimide | 98.7% sunflower oil | 114 | 4002 | lackified | lackified |
| 1.0% MOAac | 98.0% sunflower oil | 109 | 116 | 1999 | lackified |

*Apparent dynamic viscosity after 60 s shear time at 300 sec⁻¹, cone/plate 20° C.
MOAac = methyltrioctylammonium trifluoroacetate
HPDimide = trihexyl(tetradecyl)phosphonium bis(trifluoromethylsulfonyl)imide
Ecoeng 500 = PEG-5-cocomonium methyl sulfate

TABLE 8a

| | | Loss on evaporation |
|---|---|---|
| Ionic liquid | Oil | after 24 hours |
| — | 99.0% sunflower oil | 4.5% |
| 0.1% MOAac | 98.9% sunflower oil | 1.9% |
| 0.3% MOAac | 98.7% sunflower oil | 0.6% |
| 0.1% HDPimide | 98.9% sunflower oil | 4.4% |
| 0.3% HDPimide | 98.7% sunflower oil | 4.2% |
| 1.0% MOAac | 98.0% sunflower oil | 1.4% |

The results above show that the loss on evaporation and the increase in viscosity of the natural ester oil are reduced by adding an ionic liquid. In addition, it has been shown that a natural ester oil containing only an amine antioxidant is “lackified” after only 24 to 48 hours whereas lackification does not occur until after 48 to 72 hours when MOAac is added as the ionic liquid. Table 9 summarizes the results of Table 8.

TABLE 9

| Sample composition | Lackification time |
|---|---|
| 99% sunflower oil + 1% amine | >24 h and <48 h |
| antioxidant | |
| Sunflower oil + 1% amine | >24 h and <48 h but reduced viscosity |
| antioxidant + IL (Ecoeng | in comparison with the standard |
| 500; HDPimide) | |
| Sunflower oil + 1% amine | >48 h and <72 h viscosity reduced |
| antioxidant + MOAac in | in comparison with the standard |
| concentrations of 0.1 to 1% | |

The examples given above show the advantageous effect of addition of ionic liquids to synthetic, mineral and natural oils with regard to the reduction in viscosity, the reduction in the loss on evaporation and the reduction in the oxidative and thermal degradation of the lubricating compositions.

1-8. (canceled)

9. A use of ionic liquids to improve the protection against oxidative and thermal degradation of lubricating compositions consisting of a mixture of
(a) 5 to 95 wt % of a base oil or a base oil mixture, based on synthetic, mineral or native oils, which are used individually or in combination,
(b) 0.05 to 40 wt % of an ionic liquid and
(c) 0.1 to 10 wt % of an additive or additive mixture.

10. The use according to claim 1, characterized in that the base oil, based on synthetic oil, is selected from an ester of an aliphatic or aromatic di-, tri- or tetracarboxylic acid with one or a mixture of C₇ to C₂₂ alcohols, consisting of a polyphenyl ether or alkylated di- or triphenyl ether, an ester of trimethylolpropane, pentaerythritol or dipentaerythritol with aliphatic C₇ to C₂₂ carboxylic acids, C₁₈ dimer acid esters with C₇ to C₂₂ alcohols, complex esters, as individual components or in any mixture, or is selected from poly-α-olefins, alkylated naphthalenes, alkylated benzenes, polyglycols, silicone oils, perfluoropolyethers.

11. The use according to claim 1, characterized in that the base oil, based on mineral oil, is selected from paraffin-basic, naphthene-basic aromatic hydrocracking oils or gas-to-liquid (GTL) fluids, biomass-to-liquid (BTL) fluids or coal-to-liquid (CTL) fluids.

12. The use according to claim 1, characterized in that the base oil, based on native oil, is selected from genetically modified triglyceride oils with a high oleic acid content, genetically modified vegetable oils with a high oleic acid content, including safflower oil, corn oil, rapeseed oil, sunflower oil, soybean oil, linseed oil, peanut oil, lesquerella oil, meadowfoam oil and palm oil.

13. The use according to claim 1, characterized in that the ionic liquid contains a cation selected from the group consisting of a quaternary ammonium cation, phosphonium cation, imidazolium cation, pyridinium cation, pyrazolium cation, oxazolium cation, pyrrolidinium cation, piperidinium cation, trialkylsulfonium cation, thiazolium cation, guanidinium cation, morpholinium cation or triazolium cation, and an anion selected from the group consisting of [PF₆]⁻, [BF₄], [CF₃CO₂]⁻, [CF₃SO₃]⁻ as well as its higher homologs [C₄F₉—SO₃]⁻ or [C₈F₁₇—SO₃]⁻ and higher perfluoroalkylsulfonates [(CF₃SO₂)₂N]⁻, [(CF₃SO₂)(CF₃COO)N]⁻, Cl⁻, Br⁻, [R⁴—SO₃]⁻, [R⁴—O—SO₃]⁻, [R⁴—COO]⁻, [NO₃]⁻, [N(CN)₂]⁻, [HSO₄]⁻, PF₍₆₋ₓ₎R⁶ₓ or [R⁴R⁵PO₉]⁻ and the radicals R⁴ and R⁵ independently of one another are selected from hydrogen; linear or branched, saturated or unsaturated, aliphatic or alicyclic alkyl groups with 1 to 20 carbon atoms; heteroaryl, heteroaryl-C₁-C₆-alkyl groups with 3 to 8 carbon atoms in the heteroaryl radical and at least one heteroatom of N, O and S, which may be substituted with at least one group selected from C₁-C₆ alkyl groups and/or halogens; aryl-aryl C₁-C₆ alkyl groups with 5 to 12 carbon atoms in the aryl radical which may be substituted with at least one C₁-C₆ alkyl group; R⁶ may be a perfluoroethyl or higher perfluoroalkyl group, x is 1 to 4.

14. The use according to claim 1, characterized in that the ionic liquid is selected from the group consisting of butylmethylpyrrolidinium bis(trifluoromethylsulfonyl)imide, methylpropylpyrrolidinium bis(trifluoromethylsulfonyl)imide, hexylmethylimidazolium tris(perfluoroethyl) trifluorophosphate, hexylmethylimidazolium bis(trifluoromethylsulfonyl)imide, hexylmethylpyrrolidinium bis(trifluoromethylsulfonyl)imide, tetrabutylphosphonium tris(perfluoroethyl) trifluorophosphate, octylmethylimidazolium hexafluorophosphate, hexylpyridinium bis(trifluoromethyl)sulfonylimide, methyltrioctylammonium trifluoroacetate, butylmethylpyrrolidinium tris(penta-fluoroethyl) trifluorophosphate, trihexyl(tetradecyl)phosphonium bis(trifluoromethyl-sulfonyl)imide.

15. The use according to claim 1, characterized in that the additive mixture, which is optionally present, is selected from the group consisting of anticorrosion agents, antioxidants, wear preventives, friction reducing agents, agents to protect against the effects of metal, UV stabilizers, organic or inorganic solid lubricants selected from polyimide, polytetrafluoroethylene (PTFE), graphite, metal oxides, boron nitride, molybdenum disulfide and phosphate.
